(19) United States
(12) Patent Application Publication
(10) Pub. No.: US 2026/0142795 A1
(43) Pub. Date: May 21, 2026

(54) ELECTRONIC APPARATUS AND CONTROLLING METHOD THEREOF

(71) Applicant: CRYPTO LAB INC., Seoul (KR)

(72) Inventors: Jung Hee Cheon, Seoul (KR); Taekyung Kim, Seoul (KR); Michael Pak, Portland, OR (US)

(21) Appl. No.: 19/378,728

(22) Filed: Nov. 4, 2025

(30) Foreign Application Priority Data
Nov. 4, 2024 (KR) 10-2024-0154384
Oct. 31, 2025 (KR) 10-2025-0161689

(51) Int. Cl. H04L 9/00; H04L 9/06

(52) U.S. Cl. CPC H04L 9/008; H04L 9/0618

(57) ABSTRACT

An electronic apparatus processing homomorphic encryption includes at least one processor including processing circuitry and memory, and the at least one processor is configured to obtain a first ciphertext by performing homomorphic encryption on plaintext data with a first secret key, obtain, through a first key switching module, a second ciphertext corresponding to a second secret key based on the first ciphertext, transmit the second ciphertext to the second key switching module, obtain, through a second key switching module, a third ciphertext corresponding to a third secret key based on the second ciphertext, transmit the third ciphertext to a decryption module, and obtain, through the decryption module, the plaintext data by decrypting the third ciphertext based on the third secret key.

### TECHNICAL FIELD

The disclosure relates to an electronic apparatus and a controlling method thereof, and more particularly to an electronic apparatus that uses a plurality of secret keys in decrypting a homomorphic encryption computation result and a controlling method thereof.

### BACKGROUND ART

A homomorphic encryption computation system may have a structure of obtaining an original computation result by decrypting the result with a specific secret key after performing computation in a ciphertext state. If one secret key is used in the decrypting, leakage of the secret key may lead to data encrypted by the relevant key and the computation result being leaked. For example, if a secret key of data owner A is leaked to the outside, an attacker may decrypt not only ciphertext of A, but also the computation result performed for the ciphertext of A.

Even when a design (e.g., secret key per user, detachment key per service, etc.) in which a plurality of secret keys is present is introduced, if all secret keys are centrally stored and managed by one subject, several keys may be simultaneously leaked from the central management point. In other words, even with a plurality of keys, a ‘joint management’ method may generate a single point of failure in security.

### DISCLOSURE

### Technical Solution

The disclosure has been designed to improve the above-described problems, and an object of the disclosure lies in providing an electronic apparatus that performs key switching before performing decrypting and changing a secret key and a controlling method thereof.

According to an embodiment, an electronic apparatus processing homomorphic encryption includes at least one processor 110 including processing circuitry, and memory 120, and the at least one processor 110 is configured to obtain a first ciphertext [E1(m1, S1)] by performing homomorphic encryption on plaintext data m1 with a first secret key S1, obtain, through a first key switching module 21, a second ciphertext [E2(m1, S2)] corresponding to a second secret key S2 based on the first ciphertext [E1(m1, S1)], transmit the second ciphertext [E2(m1, S2)] to the second key switching module 22, obtain, through a second key switching module 22, a third ciphertext [E3(m1, S3)] corresponding to a third secret key S3 based on the second ciphertext [E2(m1, S2)], transmit the third ciphertext [E3(m1, S3)] to the decryption module 30, and obtain, through the decryption module 30, the plaintext data m1 by decrypting the third ciphertext [E3(m1, S3)] based on the third secret key S3.

The at least one processor 110 may be configured to receive input data [E0(m0, S1)] encrypted with the first secret key S1, and obtain, through a homomorphic encryption calculating module 11, the first ciphertext [E1(m1, S1)] by performing a pre-set homomorphic encryption computation with respect to the input data [E0(m0, S1)].

The first key switching module 21 may include a first function that converts a ciphertext corresponding to the first secret key S1 to a ciphertext corresponding to the second secret key S2.

The second key switching module 22 may include a second function that converts a ciphertext corresponding to the second secret key S2 to a ciphertext corresponding to the third secret key S3.

The decryption module 30 may be a module that performs decryption of a ciphertext corresponding to the third secret key S3.

The electronic apparatus may include a communication interface 130, and at least one processor 110 may be configured to receive, through the communication interface 130, a user input for decrypting the first ciphertext [E1(m1, S1)] from an external apparatus, and transmit, based on the second ciphertext [E2(m1, S2)] being obtained based on the user input, the second ciphertext [E2(m1, S2)] to the second key switching module 22.

The at least one processor 110 may be configured to generate, based on the second ciphertext [E2(m1, S2)] being obtained based on the user input, a first control signal including a first command for transmitting a decryption result to the external apparatus and a second command for requesting key switching of the second ciphertext [E2(m1, S2)], and transmit the first control signal and the second ciphertext [E2(m1, S2)] to the second key switching module 22.

The at least one processor 110 may be configured to convert, based on the first control signal being generated, the second ciphertext [E2(m1, S2)] to the third ciphertext [E3(m1, S3)] through the second key switching module 22, and transmit, based on the third ciphertext [E3(m1, S3)] being obtained, the third ciphertext [E3(m1, S3)] to the decryption module 30.

The at least one processor 110 may be configured to generate, based on the third ciphertext [E3(m1, S3)] being obtained, a second control signal including the first command for transmitting the decryption result to the external apparatus and a third command for requesting decryption of the third ciphertext [E3(m1, S3)], and transmit the second control signal and the third ciphertext [E3(m1, S3)] to the decryption module 30.

The at least one processor 110 may be configured to obtain, based on the second control signal being generated, the plaintext data m1 by decrypting the third ciphertext [E3(m1, S3)] with the third secret key S3 through the decryption module 30, and transmit, based on the plaintext data m1 being obtained, the plaintext data m1 to the external apparatus based on the first command through the communication interface 130.

According to an embodiment, a homomorphic encryption system includes a first electronic apparatus, a second electronic apparatus, and a third electronic apparatus, in which the first electronic apparatus 100-1 is configured to obtain a first ciphertext [E1(m1, S1)] by performing homomorphic encryption on plaintext data m1 with a first secret key S1, obtain, through a first key switching module 21, a second ciphertext [E2(m1, S2)] corresponding to a second secret key S2 based on the first ciphertext [E1(m1, S1)], and transmit the second ciphertext [E2(m1, S2)] to the second electronic apparatus 100-2, in which the second electronic apparatus 100-2 is configured to receive the second ciphertext [E2(m1, S2)], obtain, through a second key switching module 22, a third ciphertext [E3(m1, S3)] corresponding to a third secret key S3 based on the second ciphertext [E2(m1, S2)], and transmit the third ciphertext [E3(m1, S3)] to the third electronic apparatus 100-3, and in which the third electronic apparatus 100-3 is configured to receive the third ciphertext [E3(m1, S3)], and obtain, through a decryption module 30, the plaintext data m1 by decrypting the third ciphertext [E3(m1, S3)] based on the third secret key S3.

The first electronic apparatus 100-1 may be configured to receive input data [E0(m0, S1)] encrypted with the first secret key S1, and obtain, through a homomorphic encryption calculating module 11, the first ciphertext [E1(m1, S1)] by performing a pre-set homomorphic encryption computation with respect to the input data [E0(m0, S1)].

The first key switching module 21 may include a first function that converts a ciphertext corresponding to the first secret key S1 to a ciphertext corresponding to the second secret key S2.

The second key switching module 22 may include a second function that converts a ciphertext corresponding to the second secret key S2 to a ciphertext corresponding to the third secret key S3.

The decryption module 30 may be a module that performs decryption of a ciphertext corresponding to the third secret key S3.

The first electronic apparatus 100-1 may be configured to receive a user input for decrypting the first ciphertext [E1(m1, S1)] from an external apparatus, and transmit, based on the second ciphertext [E2(m1, S2)] being obtained based on the user input, the second ciphertext [E2(m1, S2)] to the second electronic apparatus 100-2.

The first electronic apparatus 100-1 may be configured to generate, based on the second ciphertext [E2(m1, S2)] being obtained based on the user input, a first control signal including a first command for transmitting a decryption result to the external apparatus and a second command for requesting key switching of the second ciphertext [E2(m1, S2)], and transmit the first control signal and the second ciphertext [E2(m1, S2)] to the second electronic apparatus 100-2.

The second electronic apparatus 100-2 may be configured to convert, based on the first control signal and the second ciphertext [E2(m1, S2)] being received, the second ciphertext [E2(m1, S2)] to the third ciphertext [E3(m1, S3)] through the second key switching module 22, and transmit, based on the third ciphertext [E3(m1, S3)] being obtained, the third ciphertext [E3(m1, S3)] to the third electronic apparatus 100-3.

The second electronic apparatus 100-2 may be configured to generate, based on the third ciphertext [E3(m1, S3)] being obtained, a second control signal including the first command for transmitting the decryption result to the external apparatus and a third command for requesting decryption of the third ciphertext [E3(m1, S3)], and transmit the second control signal and the third ciphertext [E3(m1, S3)] to the third electronic apparatus 100-3.

The third electronic apparatus 100-3 may be configured to obtain, based on the second control signal and the third ciphertext [E3(m1, S3)] being received, the plaintext data m1 by decrypting the third ciphertext [E3(m1, S3)] with the third secret key S3 through the decryption module 30, and transmit, based on the plaintext data m1 being obtained, the plaintext data m1 to the external apparatus based on the first command.

### DESCRIPTION OF DRAWINGS

FIG. 1 is a diagram illustrating a structure of a network system according to an embodiment;

FIG. 2 is a diagram illustrating a structure of a network system according to an embodiment;

FIG. 3 is a block diagram illustrating an electronic apparatus according to an embodiment;

FIG. 4 is a diagram illustrating a key switching node according to an embodiment;

FIG. 5 is a diagram illustrating an operation for obtaining plaintext data with a plurality of key switching operations according to an embodiment;

FIG. 6 is a diagram illustrating an operation for obtaining plaintext data using a plurality of key switching nodes according to an embodiment;

FIG. 7 is a diagram illustrating a process in which key switching is performed in a plurality of apparatuses according to an embodiment;

FIG. 8 is a diagram illustrating a key switching module included in each of a plurality of apparatuses according to an embodiment;

FIG. 9 is a diagram illustrating a homomorphic encryption computation and a key switching operation being performed in a same apparatus according to an embodiment;

FIG. 10 is a diagram illustrating a key switching and a decrypting operation being performed in a same apparatus according to an embodiment;

FIG. 11 is a diagram illustrating an operation for obtaining plaintext data from a plurality of networks according to an embodiment;

FIG. 12 is a diagram illustrating an operation for obtaining plaintext data individually from each of a plurality of networks according to an embodiment;

FIG. 13 is a diagram illustrating an operation for dividing key switching into a plurality of levels according to an embodiment;

FIG. 14 is a diagram illustrating an operation for obtaining a plurality of decrypting calculation results by each of a plurality of decryption modules according to an embodiment; and

FIG. 15 is a diagram illustrating an operation for obtaining a plurality of decrypting calculation results by one decryption module, respectively, according to an embodiment

### MODE FOR INVENTION

The disclosure will be described in detail below with reference to the accompanying drawings.

Terms used in describing one or more embodiments of the disclosure are general terms selected that are currently widely used considering their function herein. However, the terms may change depending on intention, legal or technical interpretation, emergence of new technologies, and the like of those skilled in the related art. Further, in certain cases, there may be terms arbitrarily selected, and in this case, the meaning of the term will be disclosed in greater detail in the relevant description. Accordingly, the terms used herein are not to be understood simply as its designation but based on the meaning of the term and the overall context of the disclosure.

In the disclosure, expressions such as “have”, “may have”, “include”, or “may include” are used to designate a presence of a relevant characteristic (e.g., elements such as numerical value, function, operation, or component), and not to preclude a presence of additional characteristics.

The expression at least one of A and/or B is to be understood as indicating any one of “A” or “B” or “A and B”.

Expressions such as “1st”, “2nd”, “first”, or “second” used in the disclosure may limit various elements regardless of order and/or importance, and may be used merely to distinguish one element from another element and not limit the relevant element.

When a certain element (e.g., first element) is indicated as being “(operatively or communicatively) coupled with/to” or “connected to” another element (e.g., second element), it may be understood as the certain element being directly coupled with/to the another element or as being coupled through other element (e.g., third element).

A singular expression includes a plural expression, unless otherwise explicitly specified in the context. It is to be understood that the terms such as “form” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

The term “module” or “part” used herein perform at least one function or operation, and may be implemented with hardware or software, or implemented with a combination of hardware and software. In addition, a plurality of “modules” or a plurality of “parts”, except for a “module” or a “part” which needs to be implemented with a specific hardware, may be integrated in at least one module and implemented as at least one processor.

In the disclosure, the term “user” may refer to a person using an electronic apparatus or an apparatus (e.g., artificial intelligence electronic device) using the electronic apparatus.

Further, in the disclosure, the term “value” may be defined as concept that not only includes a scalar value, but also a vector.

Mathematical computations and calculations in each step of the disclosure which will be described below may be implemented as a relevant computation or a computer computation by a publically known coding method to perform the relevant computation or calculation and/or a coding appropriately designed in the disclosure.

A specific Equation described below may be described as an example among several possible alternatives, and it is to be understood that the claimed scope of the disclosure is not limited by the Equation mentioned in the disclosure.

For convenience of description, the following transcriptions will be used in the disclosure.
a←D: Select element (a) according to distribution (D).
s1, s2∈R: Each of S1 and S2 are elements belonging to set R.
mod(q): modular computation with element q
└•┐: round off internal value

Various embodiments of the disclosure will be described in detail below using the accompanied drawings.

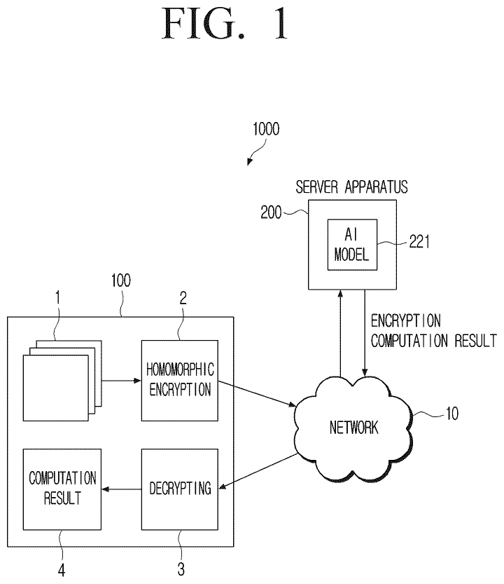

FIG. 1 is a diagram illustrating a structure of a network system 1000 according to an embodiment.

Referring to FIG. 1, an electronic apparatus 100 and a server apparatus 200 may perform communication with each other through a network 10. The network 10 may be implemented with a wire/wireless communication network, a broadcast communication network, an optical communication network, a cloud network, and the like of various forms, and each of the apparatuses may be connected through methods such as, for example, and without limitation, Wi-Fi, Bluetooth, near field communication (NFC), and the like without a separate medium.

In FIG. 1, although one electronic apparatus 100 is shown, the electronic apparatus 100 may be implemented as various types in plurality. As an example, the electronic apparatus 100 may be an apparatus of various types such as, for example, and without limitation, a smartphone, a tablet, a PC, a laptop PC, a home server, a kiosk, a game player, a camera, and the like. In addition thereto, the above may also be implemented in a home appliance product form applied with an IoT function.

As an example, if a camera is provided in the electronic apparatus 100, the electronic apparatus 100 may directly capture and obtain at least one original data 1. If the camera is not provided, the electronic apparatus 100 may receive and store the original data 1 through various wired or wireless interfaces from an external apparatus (e.g., camera, memory stick, etc.). In various embodiments of the disclosure, the original data 1 may be a photograph image, but is not necessarily limited thereto, and may be a graphic image. Alternatively, the above may be a video content that includes a plurality of image frames.

The electronic apparatus 100 may perform homomorphic encryption 2 with respect to at least one original data, obtain a homomorphic ciphertext, and then transmit the homomorphic ciphertext to the server apparatus 200 through the network 10.

In this case, there may be a possibility of the original data 1 being hacked during a process of being transmitted and leaked to the outside, or leaked by a manager of the server apparatus 200. However, if the original data is transmitted in a homomorphic ciphertext form, the original data may not be identified even if leaked to the outside, Accordingly, security for personal information or physical characteristics of a user may be reinforced.

There may be various homomorphic encryption algorithms that generate homomorphic ciphertexts, but various embodiments of the disclosure will be described based on performing homomorphic encryption using a CKKS Scheme or a modified algorithm based therefrom.

In order to transmit the original data in the homomorphic ciphertext form, the electronic apparatus 100 may perform encoding. Encoding in homomorphic encryption may be an operation for converting data to an encryptable form. Because the homomorphic encryption is based on a mathematical structure (e.g., polynomial computation), in the case of the original data 1, homomorphic encryption may be performed after converting to a form processable by a homomorphic encryption algorithm.

In the homomorphic encryption, a slot encoding method and a coefficient encoding may be used in general.

Slot encoding may be a method that performs encoding as a whole slot unit after allocating data to be encrypted into a plurality of slots. A slot may mean a data unit which can be stored in parallel in one homomorphic ciphertext. If the ciphertext is represented in a polynomial form, a coefficient or radices (roots) of the polynomial may perform a role of each slot. If one ciphertext is formed of a total of n-number of slots, an n-number of values may be simultaneously performed with encoding or computation. In other words, if slot encoding is performed, a parallel computation for the homomorphic ciphertext may be performed. The slot encoding method may various according to the homomorphic encryption algorithm. The above-described CKKS scheme may perform slot encoding using a Fast Fourier Transform (FFT).

Coefficient encoding may be a method for converting data to be encrypted to a polynomial form, and converting coefficients of the polynomial to an encrypted value. The above-described CKKS scheme may perform the coefficient encoding using a Discrete Fourier Transform (DFT).

According to an embodiment of the disclosure, the electronic apparatus 100 may perform a CinS encoding. The CinS encoding may mean a method for encoding by performing DFT with respect to a plurality of slot periods rather than the whole slot after performing slot encoding. The above will be described in detail in parts described below.

In the disclosure, data encoded with a CinS encoding method may be referred to as CinS encoding data. The electronic apparatus 100 may transmit a homomorphic ciphertext which performed homomorphic encryption 2 of CinS encoding data to the server apparatus 200.

The server apparatus 200 may be an apparatus for providing an encrypted computation result by performing computation in the homomorphically encrypted state with respect to a homomorphic ciphertext (i.e., at least one original data that is homomorphically encrypted) provided from the electronic apparatus 100. The server apparatus 200 may be implemented in various forms such as a web server or a cloud server.

In the server apparatus 200, an AI model 221 for performing computation in the encrypted state may be stored. As described above, if original data is provided and computation is performed based on the original data, the AI model 221 may be a convolutional neural network (CNN), but is not necessarily limited thereto.

Specifically, the AI model 221 may perform various computations with respect to the homomorphic ciphertext encrypted with homomorphic encryption (e.g., CKKS Scheme) technology, and output the computation result thereof in the homomorphic ciphertext form. The computation result output in the homomorphic ciphertext form may be referred to as an encrypted computation result below.

If the AI model 221 is configured with CNN, the AI model 221 of the server apparatus 200 may perform a convolution computation for each depth or convolution computation using a model parameter with respect to the homomorphic ciphertext transmitted from the electronic apparatus 100. The computation method described above will be described in detail in parts described below.

The server apparatus 200 may transmit the encrypted computation result to the electronic apparatus 100 through the network 10. The electronic apparatus 100 may perform decrypting 3m on the received encrypted computation result, and provide the user with a computation result 4 thereof. A result providing method may vary according to types and configurations of the electronic apparatus 100.

As an example, if the electronic apparatus 100 includes a display, or if connected with an external display (e.g., monitor), the decrypted computation result 4 may be displayed.

As an example, if the electronic apparatus 100 includes a speaker, a voice message corresponding to the computation result may be output through the speaker.

As an example, if the electronic apparatus 100 is performing communication with other terminal apparatuses (e.g., smartphones, etc.), the decrypted computation result may be provided by transmitting to the terminal apparatus.

As an example, if the AI model 221 is a model trained to diagnose whether or not there is a disease, the computation result may include information about the presence or absence of a disease, a type of the disease, a state of progression, and the like diagnosed based on the original data 1 of the user.

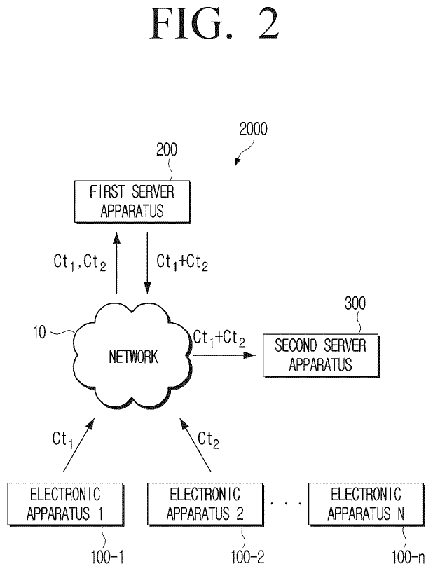

FIG. 2 is a diagram illustrating a structure of a network system 2000 according to an embodiment.

Referring to FIG. 2, a network system may include a plurality of electronic apparatuses 100-1 to 100-n, a first server apparatus 200, and a second server apparatus 300, and each of the configurations may be connected with one another through the network 10.

The network 10 may be implemented with the wire/wireless communication network, the broadcast communication network, the optical communication network, the cloud network, and the like of various forms, and each of the apparatuses may be connected through methods such as, for example, and without limitation, Wi-Fi, Bluetooth, near field communication (NFC), and the like without a separate medium.

In FIG. 2, the electronic apparatus has been shown as in plurality 100-1 to 100-n, but the electronic apparatus may not necessarily be used in plurality, and one apparatus may be used. As an example, the electronic apparatuses 100-1 to 100-n may be implemented as apparatuses of various forms such as, for example, and without limitation, a smartphone, a tablet, a game player, a PC, a laptop PC, a home server, a kiosk, and the like, and may also be implemented in the home appliance product form applied with the IoT function in addition thereto.

The user may input various information through the electronic apparatuses 100-1 to 100-n that the user uses. The input information may be stored in the electronic apparatuses 100-1 to 100-n themselves, but may be transmitted and stored in an external apparatus for reasons such as storage capacity and security. In FIG. 2, the first server apparatus 200 may perform a role of storing the information described, and the second server apparatus 300 may perform a role of using a portion or all of the information stored in the first server apparatus 200.

Each of the electronic apparatuses 100-1 to 100-n may perform homomorphic encryption of the input information, and transmit the homomorphic ciphertext to the first server apparatus 200.

Each of the electronic apparatus 100-1 to 100-n may include encryption noise, in other words, an error that is calculated in a process of performing homomorphic encryption in a ciphertext. Specifically, the homomorphic ciphertext generated from each of the electronic apparatuses 100-1 to 100-n may be generated in a form in which a result value including a message and an error value is restored when performing decrypting later using a secret key.

As an example, the homomorphic ciphertext generated from the electronic apparatuses 100-1 to 100-n may be generated in a form that satisfies the properties below when performing decrypting using the secret key.

$$Dec ( st , sk ) = 〈 ct , sk 〉 = M + e ( mod q ) \qquad [ Equation 1 ]$$

Here, <, > denotes a usual inner product, ct denotes a ciphertext, sk denotes a secret key, M denotes a plaintext message, e denotes an encryption error value, and mod q denotes a modulus of the ciphertext. q is to be selected greater than M which is a result value obtained by a scaling factor(Δ) being multiplied to a message. If an absolute value of error value e is sufficiently smaller compared to M, a decrypting value M+e of the ciphertext may be a value which can substitute an original message from a significant numeric computation to a same degree of precision. An error from among decrypted data may be arranged at a least significant bit (LSB) side, and M may be arranged at a second least significant bit side.

If a size of a message to too small or too great, the size may be adjusted using the scaling factor. If the scaling factor is used, because not only a message in an integer number form but even a message in a real number form may be encrypted, utilization may be greatly increased. In addition, by adjusting the size of the message using the scaling factor, regions in which messages are present in the ciphertext after a computation is carried out, in other words, a size of an effective region may also be adjusted.

According to an embodiment, ciphertext modulus q may be used set to various forms. As an example, the modulus of the ciphertext may be set to an exponentiation q=ΔL form of scaling factor Δ. If Δ is 2, the above may be set to a value such as q=210.

Further, the homomorphic ciphertext according to the disclosure has been described assuming that a fixed point is used, but may be applied to even when a floating point is used.

The first server apparatus 200 may not decrypt the received homomorphic ciphertext, and store in a ciphertext state.

The second server apparatus 300 may request a specific processing result for the homomorphic ciphertext to the first server apparatus 200. The first server apparatus 200 may perform a specific computation according to the request of the second server apparatus 300, and then transmit the result thereof to the second server apparatus 300.

As an example, if ciphertexts ct1 and ct2 transmitted by two electronic apparatuses 100-1 and 100-2 are stored in the first server apparatus 200, the second server apparatus 300 may request for a value that summed the information provided from the two electronic apparatuses 100-1 and 100-2 to the first server apparatus 200. The first server apparatus 200 may transmit, after performing computation for summing the two ciphertexts according to the request, the result value thereof (ct1+ct2) to the second server apparatus 300.

Based on the properties of the homomorphic ciphertext, the first server apparatus 200 may perform computation in a state in which decryption is not performed, and the result value thereof may also be in a ciphertext form. In the disclosure, the result value obtained by computation may be referred to as a computation result ciphertext,

The first server apparatus 200 may transmit the computation result ciphertext to the second server apparatus 300. The second server apparatus 300 may obtain, by decrypting the received computation result ciphertext, computation result values of data included in each of the homomorphic ciphertexts.

Meanwhile, the electronic apparatus 100 may obtain a homomorphic ciphertext using a Residual Number System (RNS) modulus that includes a plurality of moduli having a size corresponding to a word size of the electronic apparatus 100, and perform computation on the homomorphic ciphertext using a Rational Rescale. In one or more embodiments, the plurality of moduli may include sprout moduli formed of multiplication of prime numbers having a size less than or equal to the word size, and the electronic apparatus 100 may perform various computations (e.g., key switching computation, etc.) on the homomorphic ciphertext using the sprout moduli. In one or more embodiments, the electronic apparatus 100 may generate an intermediate modulus by up-scaling the RNS modulus, perform a key switching computation on the intermediate modulus, and perform the key switching computation on the homomorphic ciphertext by performing a re-scaling of the intermediate modulus performed with the key switching computation.

Thereby, the electronic apparatus 100 may be able to perform computation on the homomorphic ciphertext more quickly due to being able to perform an effective multiplication computation while minimizing the number of the RNS modulus.

Meanwhile, in FIG. 2, although an example of encryption being performed from the first electronic apparatus and the second electronic apparatus, and the second sever apparatus performing decryption has been shown, the embodiment is not necessarily limited thereto.

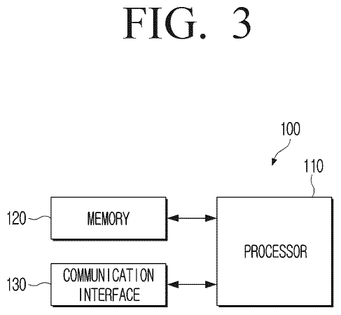

FIG. 3 is a block diagram illustrating a configuration of an electronic apparatus according to an embodiment.

As an example, the electronic apparatus 100 may indicate one apparatus.

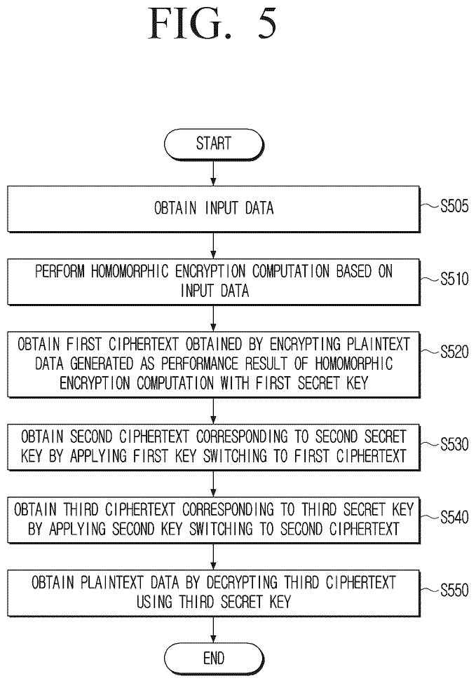

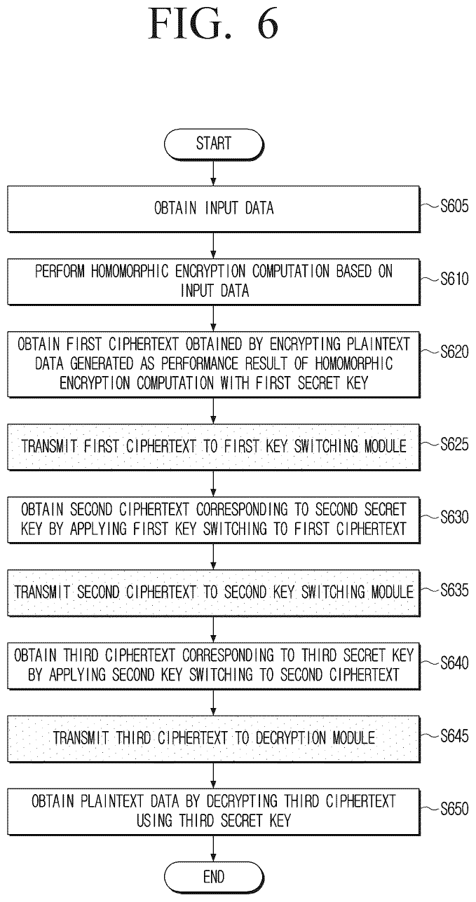

An operation of the one electronic apparatus 100 performing a plurality of key switching operations will be described in FIG. 5 and FIG. 6.

The electronic apparatus 100 processing homomorphic encryption may include at least one processor 110 including processing circuitry and memory 120.

The at least one processor 110 may perform an overall control operation of the electronic apparatus 100. The at least one processor 110 may perform a function controlling the overall operation of the electronic apparatus 100.

The at least one processor 110 maybe implemented as a digital signal processor (DSP) for processing digital signals, a microprocessor, or a time controller (TCON). However, the embodiment is not limited thereto, and may include one or more from among a central processing unit (CPU), a micro controller unit (MCU), a micro processing unit (MPU), a controller, an application processor (AP), a graphics-processing unit (GPU) or a communication processor (CP), an advanced reduced instruction set computer (RISC) machines (ARM) processor, or may be defined by a relevant term. The at least one processor 110 may be implemented as a System on Chip (SoC) or a large scale integration (LSI) in which a processing algorithm is embedded, and may be implemented in a form of a field programmable gate array (FPGA). The at least one processor 110 may perform various functions by executing computer executable instructions stored in memory.

The memory embedded in the electronic apparatus 100 may be implemented as at least one of a volatile memory (e.g., dynamic RAM (DRAM), static RAM (SRAM), synchronous dynamic RAM (SDRAM), or the like), or a non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash), hard drive or solid state drive (SSD)), and the memory attachable to or detachable from the electronic apparatus 100, the memory may be implemented in a form such as, for example, and without limitation, a memory card (e.g., compact flash (CF), secure digital (SD), micro secure digital (micro-SD), mini secure digital (mini-SD), extreme digital (xD), multi-media card (MMC), etc.), external memory (e.g., USB memory) connectable to a USB port, or the like.

The memory 120 may be implemented as an internal memory such as a ROM (e.g., electrically erasable programmable read-only memory (EEPROM)) and a RAM included in the at least one processor 110, or implemented as a memory separate from the at least one processor 110. The memory 120 may be implemented in a form of a memory embedded in the electronic apparatus 100 according to a data storage use, or in a form of a memory attachable to or detachable from the electronic apparatus 100. For example, data for driving the electronic apparatus 100 may be stored in the memory embedded in the electronic apparatus 100, and data for an expansion function of the electronic apparatus 100 may be stored in the memory attachable to or detachable from the electronic apparatus 100.

The memory 120 may store at least one instruction. The at least one processor 110 may perform various operations based on the instructions stored in the memory 120.

A communication interface 130 maybe a configuration for performing communication with external apparatuses of various types according communication methods of various types. The communication interface 130 may include a wireless communication module or a wired communication module. Each communication module may be implemented as at least one hardware chip form.

The wireless communication module may be a module for communicating with the external apparatus by wireless means. For example, the wireless communication module may include at least one module from among a Wi-Fi module, a Bluetooth module, an infrared communication module, or other communication modules.

The Wi-Fi module and the Bluetooth module may respectively perform communication using a Wi-Fi method, and a Bluetooth method. When using the Wi-Fi module or the Bluetooth module, various connection information such as a service set identifier (SSID) and a session key may first be transmitted and received, and may transmit and receive various information after communicatively connecting using the same.

The infrared communication module may perform communication according to an infrared communication (Infrared Data Association (IrDA)) technology of transmitting data wirelessly in short range using infrared rays present between visible rays and millimeter waves.

The other communication modules may include at least one communication chip that performs communication according to various wireless communication standards such as, for example, and without limitation, ZigBee, 3rd Generation (3G), 3rd Generation Partnership Project (3GPP), Long Term Evolution (LTE), LTE Advanced (LTE-A), 4th Generation (4G), 5th Generation (5G), and the like, in addition to the above-described communication methods.

The wired communication module may be a module that communicates with an external apparatus via wired means. For example, the wired communication module may include at least one from among In addition thereto, the communication interface 110 may include at least one from among a local area network (LAN) module, an Ethernet module, a pair cable, a coaxial cable, an optical fiber cable, or an ultra wide-band (UWB) module.

According to an embodiment, the communication interface 130 may use the same communication module (e.g., Wi-Fi module) for communicating with an external apparatus such as a remote control apparatus and an external server.

According to an embodiment, the communication interface 130 may use different communication modules to communicate with the external apparatus such as the remote control apparatus and the external server. For example, the communication interface 130 may use at least one of an Ethernet module or the Wi-Fi module to communicate with the external server, and use the Bluetooth module to communicate with the external apparatus such as the remote control apparatus. However, the above is merely one embodiment, and the communication interface 130 may use at least one communication module from among various communication modules when communicating with a plurality of external apparatuses or the external server.

The at least one processor 110 may obtain a first ciphertext [E1(m1, S1)] by performing homomorphic encryption on plaintext data m1 with a first secret key S1.

The at least one processor 110 may obtain, through a first key switching module 21, a second ciphertext [E2(m1, S2)] corresponding to a second secret key S2 based on the first ciphertext [E1(m1, S1)].

The at least one processor 110 may transmit the second ciphertext [E2(m1, S2)] to a second key switching module 22.

The at least one processor 110 may obtain, through the second key switching module 22, a third ciphertext [E3(m1, S3)] corresponding to a third secret key S3 based on the second ciphertext [E2(m1, S2)].

The at least one processor 110 may transmit the third ciphertext [E3(m1, S3)] to a decryption module 30.

The at least one processor 110 may obtain, through the decryption module 30, the plaintext data m1 by decrypting the third ciphertext [E3(m1, S3)] based on the third secret key S3.

The at least one processor 110 may receive input data [E0(m0, S1)] encrypted with the first secret key S1, and obtain, through a homomorphic encryption calculating module 11, the first ciphertext [E1(m1, S1)] by performing a pre-set homomorphic encryption computation with respect to the input data [E0(m0, S1)].

The first key switching module 21 may include a first function that converts a ciphertext corresponding to the first secret key S1 to a ciphertext corresponding to the second secret key S2.

The second key switching module 22 may include a second function that converts the ciphertext corresponding to the second secret key S2 to a ciphertext corresponding to the third secret key S3.

The decryption module 30 of the electronic apparatus may be a module that performs decryption of the ciphertext corresponding to the third secret key S3.

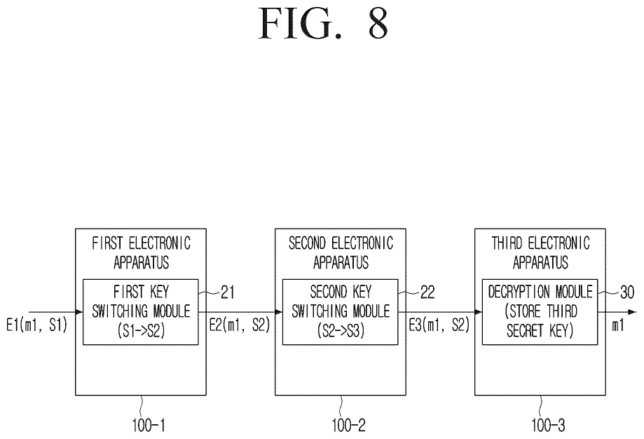

Descriptions of the first key switching module 21, the second key switching module 22, and the decryption module 30 will be provided in FIG. 8.

The electronic apparatus 100 may include the communication interface 130. The at least one processor 110 may receive, through the communication interface 130, a user input for decrypting the first ciphertext [E1(m1, S1)] from an external apparatus.

The at least one processor 110 may transmit, based on the second ciphertext [E2(m1, S2)] being obtained based on the user input, the second ciphertext [E2(m1, S2)] to the second key switching module 22.

The at least one processor 110 may generate, based on the second ciphertext [E2(m1, S2)] being obtained based on the user input, a first control signal including a first command for transmitting a decryption result to the external apparatus and a second command for requesting key switching of the second ciphertext [E2(m1, S2)]. The at least one processor 110 may transmit the first control signal and the second ciphertext [E2(m1, S2)] to the second key switching module 22.

The at least one processor 110 may convert, based on the first control signal being generated, the second ciphertext [E2(m1, S2)] to the third ciphertext [E3(m1, S3)] through the second key switching module 22. The at least one processor 110 may transmit, based on the third ciphertext [E3(m1, S3)] being obtained, the third ciphertext [E3(m1, S3)] to the decryption module 30.

The at least one processor 110 may generate, based on the third ciphertext [E3(m1, S3)] being obtained, a second control signal including the first command for transmitting the decryption result to the external apparatus and a third command for requesting decryption of the third ciphertext [E3(m1, S3)]. The at least one processor 110 may transmit the second control signal and the third ciphertext [E3(m1, S3)] to the decryption module 30.

The at least one processor 110 may obtain, based on the second control signal being generated, the plaintext data m1 by decrypting the third ciphertext [E3(m1, S3)] with the third secret key S3 through the decryption module 30. The at least one processor 110 may transmit, based on the plaintext data m1 being obtained, the plaintext data m1 to the external apparatus based on the first command through the communication interface 130.

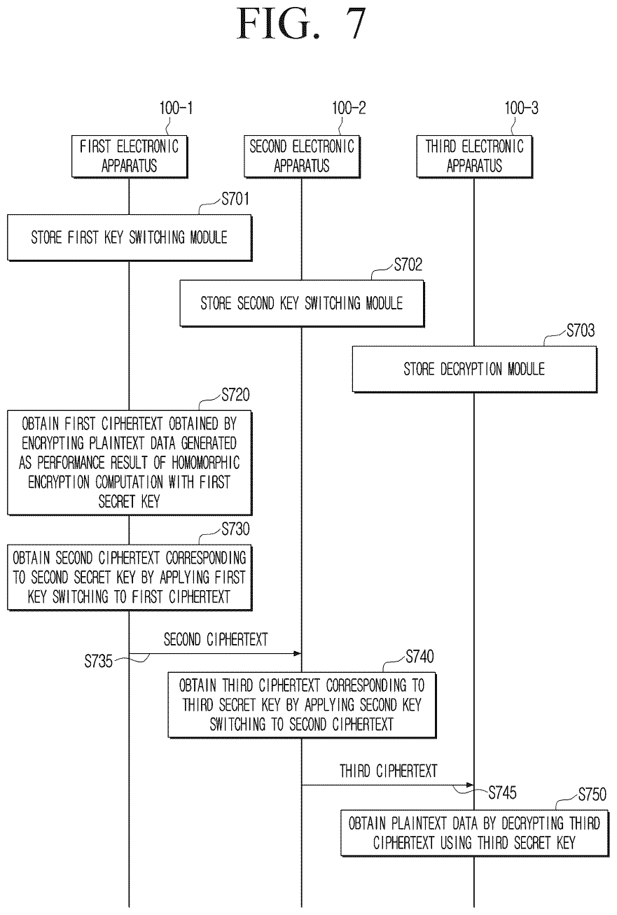

According to an embodiment, a homomorphic encryption system may include a first electronic apparatus 100-1, a second electronic apparatus 100-2, and a third electronic apparatus 100-3. Descriptions associated therewith will be described in FIG. 7.

The first electronic apparatus 100-1 may obtain the first ciphertext [E1(m1, S1)] by performing homomorphic encryption on the plaintext data m1 with the first secret key S1. The first electronic apparatus 100-1 may obtain, through the first key switching module 21, the second ciphertext [E2(m1, S2)] corresponding to the second secret key S2 based on the first ciphertext [E1(m1, S1)]. The first electronic apparatus 100-1 may transmit the second ciphertext [E2(m1, S2)] to the second electronic apparatus 100-2.

The second electronic apparatus 100-2 may receive the second ciphertext [E2(m1, S2)].

The second electronic apparatus 100-2 may obtain, through the second key switching module 22, the third ciphertext [E3(m1, S3)] corresponding to the third secret key S3 based on the second ciphertext [E2(m1, S2)].

The second electronic apparatus 100-2 may transmit the third ciphertext [E3(m1, S3)]to the third electronic apparatus 100-3.

The third electronic apparatus 100-3 may receive the third ciphertext [E3(m1, S3)].

The third electronic apparatus 100-3 may obtain, through the decryption module 30, the plaintext data m1 by decrypting the third ciphertext [E3(m1, S3)] based on the third secret key S3.

The first electronic apparatus 100-1 may receive the input data [E0(m0, S1)] encrypted with the first secret key S1.

The first electronic apparatus 100-1 may obtain, through the homomorphic encryption calculating module 11, the first ciphertext [E1(m1, S1)] by performing the pre-set homomorphic encryption computation with respect to the input data [E0(m0, S1)].

The first key switching module 21 may include the first function that converts the ciphertext corresponding to the first secret key S1 to the ciphertext corresponding to the second secret key S2.

The second key switching module 22 may include a second function that converts the ciphertext corresponding to the second secret key S2 to the ciphertext corresponding to the third secret key S3.

The decryption module 30 may be a module that performs decryption of the ciphertext corresponding to the third secret key S3.

The first electronic apparatus 100-1 may receive a user input for decrypting the first ciphertext [E1(m1, S1)] from the external apparatus.

The first electronic apparatus 100-1 may transmit, based on the second ciphertext [E2(m1, S2)] being obtained based on the user input, the second ciphertext [E2(m1, S2)] to the second electronic apparatus 100-2.

The first electronic apparatus 100-1 may generate, based on the second ciphertext [E2(m1, S2)] being obtained based on the user input, the first control signal including the first command for transmitting the decryption result to the external apparatus and the second command for requesting key switching of the second ciphertext [E2(m1, S2)].

The second ciphertext [E2(m1, S2)] may transmit the first control signal and the second ciphertext [E2(m1, S2)] to the second electronic apparatus 100-2.

The second electronic apparatus 100-2 may convert, based on the first control signal and the second ciphertext [E2(m1, S2)] being received, the second ciphertext [E2(m1, S2)] to the third ciphertext [E3(m1, S3)] through the second key switching module 22.

The second electronic apparatus 100-2 may transmit, based on the third ciphertext [E3(m1, S3)] being obtained, the third ciphertext [E3(m1, S3)] to the third electronic apparatus 100-3.

The second electronic apparatus 100-2 may generate, based on the third ciphertext [E3(m1, S3)] being obtained, the second control signal including the first command for transmitting the decryption result to the external apparatus and the third command for requesting decryption of the third ciphertext [E3(m1, S3)].

The second electronic apparatus 100-2 may transmit the second control signal and the third ciphertext [E3(m1, S3)] to the third electronic apparatus 100-3.

The third electronic apparatus 100-3 may obtain, based on the second control signal and the third ciphertext [E3(m1, S3)] being received, the plaintext data m1 by decrypting the third ciphertext [E3(m1, S3)] with the third secret key S3 through the decryption module 30.

The third electronic apparatus 100-3 may transmit, based on the plaintext data m1 being obtained, the plaintext data m1 to the external apparatus based on the first command.

A plurality of secret keys may be necessary for decrypting one plaintext data m1. Accordingly, security of a decryption method of the electronic apparatus 100 may be enhanced.

In addition, the plurality of secret keys may be managed in a plurality of modules different from one another or a plurality of apparatuses different from one another. Accordingly, even if one secret key is leaked, decryption may not be possible without obtaining all of the remaining secret keys.

A homomorphic encryption processing system of the disclosure may provide a higher level of security compared to a software (SW) or hardware (HW) key protection system (e.g., HSM, Secure Enclave, Confidential Computing, TPM, SGX) of the related art.

The homomorphic encryption processing system of the disclosure may be enhanced in security because an attacker has to intrude all nodes in a decryption system.

The homomorphic encryption processing system of the disclosure may achieve a desired level of high security by applying a hardware or software security enhancing technique such as Confidential Computing.

Because the homomorphic encryption processing system of the disclosure includes a plurality of secret keys transitioning level, security may be enhanced.

The homomorphic encryption processing system of the disclosure may perform a converting operation once for every key switching module. Each module may perform the converting operation with the same secret key. Accordingly, each module may perform a converting operation that matches its level.

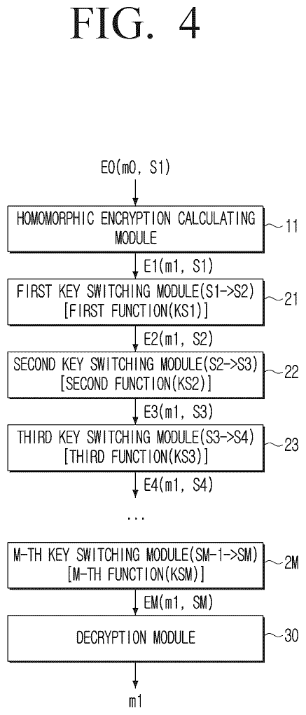

FIG. 4 is a diagram illustrating a key switching node according to an embodiment.

Referring to FIG. 4, a system for homomorphic encryption may include the homomorphic encryption calculating module 11, at least one key switching module 21, 21, 23, . . . , and 2M, and the decryption module 30.

The homomorphic encryption calculating module 11 may be a module for performing a pre-set homomorphic encryption calculation with respect to the input data [E0(m0, S1)]. The homomorphic encryption calculating module 11 may perform various computations with respect to homomorphic encryption. The homomorphic encryption calculating module 11 may perform computation on homomorphic encryption data.

The homomorphic encryption calculating module 11 may receive the input data [E0(m0, S1)] by homomorphically encrypting plaintext data m0 with the first secret key S1. The homomorphic encryption calculating module 11 may obtain the first ciphertext [E1(m1, S1)] by performing the pre-set homomorphic encryption computation with respect to the input data [E0(m0, S1)]. The first ciphertext [E1(m1, S1)] may be data that encrypted the plaintext data m1 with the first secret key S1.

The homomorphic encryption calculating module 11 may obtain the first ciphertext [E1(m1, S1)] by performing homomorphic encryption computation on the input data [E0(m0, S1)]. The homomorphic encryption calculating module 11 may transmit the obtained first ciphertext [E1(m1, S1)] to the first key switching module 21.

The key switching modules 21, 21, 23, . . . , and 2M may be modules that perform a switching operation of the secret key. The key switching modules 21, 21, 23, . . . , and 2M may be modules for changing an encrypted secret key for the plaintext data m1. The key switching modules 21, 21, 23, . . . , and 2M may generate data that encrypted the plaintext data m1 with a pre-stored (or pre-set) secret key with respect to the received ciphertext.

The key switching modules 21, 21, 23, . . . , and 2M may indicate hardware or software performing a key switching operation.

The key switching modules 21, 21, 23, . . . , and 2M may be described as the key switching node. The key switching node may indicate a hardware classification unit or a software classification unit that performs the key switching operation.

The key switching modules 21, 21, 23, . . . , and 2M may include a key switching function. The key switching function may be a function for changing the secret key for the ciphertext.

As an example, the key switching function may be different for every key switching module in all. The first key switching module 21 may store the first function. The second key switching module 22 may store the second function. A third key switching module 23 may store a third function. Each of the first function, the second function, and the third function may be different. Each function may vary according to the secret key.

The first key switching module 21 may receive the first ciphertext [E1(m1, S1)] from the homomorphic encryption calculating module 11. The first key switching module 21 may change the first secret key S1 to the second secret key S2. The first key switching module 21 may change the first ciphertext [E1(m1, S1)] to the second ciphertext [E2(m1, S2)] based on the first function. The second ciphertext [E2(m1, S2)] may be data encrypted with the second secret key S2.

The first key switching module 21 may change the first ciphertext [E1(m1, S1)] encrypted based on the first secret key S1 to the second ciphertext [E2(m1, S2)] encrypted based on the second secret key S2. The first key switching module 21 may obtain the second ciphertext [E2(m1, S2)] by applying the first ciphertext [E1(m1, S1)] to the first function. The first key switching module 21 may store the second ciphertext [E2(m1, S2)]. The first key switching module 21 may transmit the second ciphertext [E2(m1, S2)] to the second key switching module 22.

The second key switching module 22 may receive the second ciphertext [E2(m1, S2)] from the first key switching module 21. The second key switching module 22 may change the second secret key S2 to the third secret key S3. The second key switching module 22 may change the second ciphertext [E2(m1, S2)] to the third ciphertext [E3(m1, S3)] based on the second function. The third ciphertext [E3(m1, S3)] may be data encrypted with the third secret key S3.

The second key switching module 22 may change the second ciphertext [E2(m1, S2)] encrypted based on the second secret key S2 to the third ciphertext [E3(m1, S3)] encrypted based on the third secret key S3. The second key switching module 22 may obtain the third ciphertext [E3(m1, S3)] by applying the second ciphertext [E2(m1, S2)] to the second function. The second key switching module 22 may store the third ciphertext [E3(m1, S3)]. The second key switching module 22 may transmit the third ciphertext [E3(m1, S3)] to the third key switching module 23.

The third key switching module 23 may receive the third ciphertext [E3(m1, S3)] from the second key switching module 22. The third key switching module 23 may change the third secret key S3 to a fourth secret key S4. The third key switching module 23 may change the third ciphertext [E3(m1, S3)] to a fourth ciphertext [E4(m1, S4)] based on the third function. The fourth ciphertext [E4(m1, S4)] may be data encrypted with the fourth secret key S4.

The third key switching module 23 may change the third ciphertext [E3(m1, S3)] encrypted based on the third secret key S3 to the fourth ciphertext [E4(m1, S4)] encrypted based on the fourth secret key S4. The third key switching module 23 may obtain the fourth ciphertext [E4(m1, S4)] by applying the third ciphertext [E3(m1, S3)] to the third function. The third key switching module 23 may store the fourth ciphertext [E4(m1, S4)]. The third key switching module 23 may transmit the fourth ciphertext [E4(m1, S4)] to a fourth key switching module 24.

The key switching operation may be performed until an M-th key switching module 2M. The M-th key switching module 2M may obtain a ciphertext [EM(m1, SM)] encrypted with a secret key SM. The M-th key switching module 2M may transmit the ciphertext [EM(m1, SM)] to the decryption module 30.

The decryption module 30 may obtain the ciphertext [EM(m1, SM)] from the M-th key switching module 2M. The decryption module 30 may obtain the plaintext data m1 by decrypting the ciphertext [EM(m1, SM)] based on the secret key SM.

FIG. 5 is a diagram illustrating an operation for obtaining plaintext data with a plurality of key switching operations according to an embodiment.

Referring to FIG. 5, the electronic apparatus 100 may obtain the input data [E0(m0, S1)](S505). The electronic apparatus 100 may perform homomorphic encryption computation based on the input data [E0(m0, S1)](S510).

The electronic apparatus 100 may obtain the first ciphertext [E1(m1, S1)] as a performance result of the homomorphic encryption computation (S520). The electronic apparatus 100 may obtain the first ciphertext [E1(m1, S1)] by encrypting the first ciphertext [E1(m1, S1)] with the first secret key S1.

The electronic apparatus 100 may obtain the second ciphertext [E2(m1, S2)] corresponding to the second secret key S2 by applying first key switching to the first ciphertext [E1(m1, S1)](S530). The first key switching may indicate an operation for applying the first function. The first function may be a pre-set function. The first function may be a function for generating a result value for encrypting the plaintext data m1 with the second secret key S2 rather than the first secret key S1. The first function may be a function for converting the ciphertext of the first secret key S1 to the ciphertext of the second secret key S2.

The electronic apparatus 100 may obtain the third ciphertext [E3(m1, S3)] corresponding to the third secret key S3 by applying second key switching to the second ciphertext [E2(m1, S2)](S540). The second key switching may indicate an operation for applying the second function. The second function may be a pre-set function. The second function may be a function for generating a result value for encrypting the plaintext data m1 with the third secret key S3 rather than the second secret key S2. The second function may be a function for converting the ciphertext of the second secret key S2 to the ciphertext of the third secret key S3.

The electronic apparatus 100 may obtain the plaintext data m1 by decrypting the third ciphertext [E3(m1, S3)] using the third secret key S3 (S550).

FIG. 6 is a diagram illustrating an operation for obtaining plaintext data using a plurality of key switching nodes according to an embodiment.

Steps S605, S610, S620, S630, S640, and S650 in FIG. 6 may correspond to steps S505, S510, S520, S530, S540, and S550 in FIG. 5.

The key switching operation may be carried in each of the individual modules. For example, the first key switching may be performed in the first key switching module 21. The second key switching may be performed in the second key switching module 22. The third key switching may be performed in the third key switching module 23.

The first key switching module 21 may store the first function. The second key switching module 22 may store the second function. The third key switching module 23 may store the third function. Each module may change the secret key of the ciphertext based on each stored function.

Each switching module may be described as each switching node. Each switching module may be individual software or hardware.

As an example, each switching module may be present in individual apparatuses.

As an example, each switching module may be present in one apparatus.

The electronic apparatus 100 may transmit, after obtaining the first ciphertext [E1(m1, S1)], the first ciphertext [E1(m1, S1)] to the first key switching module 21 (S625).

The first key switching module 21 may change the first ciphertext [E1(m1, S1)] to the second ciphertext [E2(m1, S2)]. The first key switching module 21 may transmit the second ciphertext [E2(m1, S2)] to the second key switching module 22 (S635).

The second key switching module 22 may change the second ciphertext [E2(m1, S2)] to the third ciphertext [E3(m1, S3)]. The second key switching module 22 may transmit the third ciphertext [E3(m1, S3)] to the decryption module 30 (S645).

The decryption module 30 may obtain the plaintext data m1 by decrypting the third ciphertext [E3(m1, S3)] based on the third secret key S3.

FIG. 7 is a diagram illustrating a process in which key switching is performed in a plurality of apparatuses according to an embodiment.

Steps S720, S730, S735, S740, S745, and S750 in FIG. 7 may correspond to steps S620, S630, S635, S640, S645, and S650 in FIG. 6.

The first electronic apparatus 100-1 may store the first key switching module 21 (S701). The second electronic apparatus 100-2 may store the second key switching module 22 (S702). The third electronic apparatus 100-3 may store the decryption module 30 (S703).

The first electronic apparatus 100-1 may obtain the first ciphertext [E1(m1, S1)] as a performance result of homomorphic encryption computation (S720). The first ciphertext [E1(m1, S1)] may be a value obtained by encrypting the plaintext data m1 with the first secret key S1.

The first electronic apparatus 100-1 may obtain the second ciphertext [E2(m1, S2)] corresponding to the second secret key S2 by applying first key switching to the first ciphertext [E1(m1, S1)] through the first key switching module 21 (S730). The first electronic apparatus 100-1 may transmit the second ciphertext [E2(m1, S2)] to the second electronic apparatus 100-2 (S735).

The second electronic apparatus 100-2 may receive the second ciphertext [E2(m1, S2)] from the second electronic apparatus 100-2. The second electronic apparatus 100-2 may obtain the third ciphertext [E3(m1, S3)] corresponding to the third secret key S3 by applying second key switching to the second ciphertext [E2(m1, S2)] through the second key switching module 22 (S740). The second electronic apparatus 100-2 may transmit the third ciphertext [E3(m1, S3)] to the third electronic apparatus 100-3 (S745).

The third electronic apparatus 100-3 may receive the third ciphertext [E3(m1, S3)] from the third electronic apparatus 100-3. The third electronic apparatus 100-3 may obtain the plaintext data m1 by decrypting the third ciphertext [E3(m1, S3)] with the third secret key S3 through the decryption module 30 (S750).

FIG. 8 is a diagram illustrating a key switching module included in each of a plurality of apparatuses according to an embodiment.

Referring an embodiment of FIG. 8, the first electronic apparatus 100-1 may receive the first ciphertext [E1(m1, S1)] from the external apparatus. The first electronic apparatus 100-1 may include the first key switching module 21. The first electronic apparatus 100-1 may convert the first ciphertext [E1(m1, S1)] to the second ciphertext [E2(m1, S2)] using the first key switching module 21. The first electronic apparatus 100-1 may transmit the second ciphertext [E2(m1, S2)] to the second electronic apparatus 100-2.

The second electronic apparatus 100-2 may receive the second ciphertext [E2(m1, S2)] from the first electronic apparatus 100-1. The second electronic apparatus 100-2 may include second key switching module 22. The second electronic apparatus 100-2 may convert the second ciphertext [E2(m1, S2)] to the third ciphertext [E3(m1, S3)] using the second key switching module 22. The second electronic apparatus 100-2 may transmit the third ciphertext [E3(m1, S3)] to the third electronic apparatus 100-3.

The third electronic apparatus 100-3 may receive the third ciphertext [E3(m1, S3)] from the second electronic apparatus 100-2. The third electronic apparatus 100-3 may include the decryption module 30. The third electronic apparatus 100-3 may convert the third ciphertext [E3(m1, S3)] to the plaintext data m1 using the decryption module 30. The third electronic apparatus 100-3 may transmit the plaintext data m1 to another apparatus.

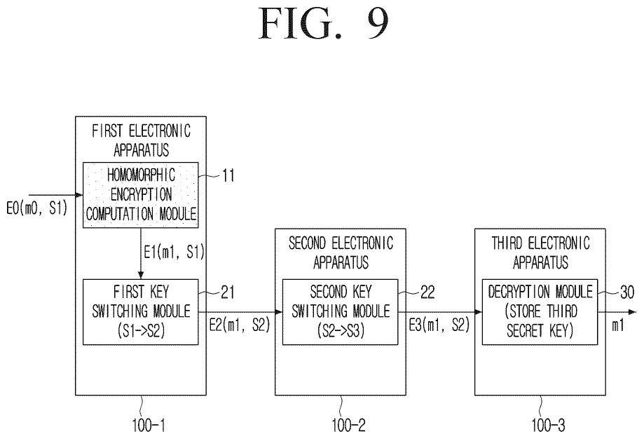

FIG. 9 is a diagram illustrating a homomorphic encryption computation and a key switching operation being performed in a same apparatus according to an embodiment.

The first electronic apparatus 100-1, the second electronic apparatus 100-2, and the third electronic apparatus 100-3 of FIG. 9 may correspond to the description of FIG. 8.

Referring to an embodiment of FIG. 9, the first electronic apparatus 100-1 may include the homomorphic encryption calculating module 11. In an embodiment of FIG. 8, the first electronic apparatus 100-1 has been described as receiving the first ciphertext [E1(m1, S1)] from the external apparatus. In an embodiment of FIG. 9, the first electronic apparatus 100-1 may directly generate the first ciphertext [E1(m1, S1)].

The first electronic apparatus 100-1 may receive the input data [E0(m0, S1)] from the external apparatus. The first electronic apparatus 100-1 may include the homomorphic encryption calculating module 11. The first electronic apparatus 100-1 may perform homomorphic encryption computation of the input data [E0(m0, S1)] using the homomorphic encryption calculating module 11.

The first electronic apparatus 100-1 may obtain the first ciphertext [E1(m1, S1)] as a performance result of the homomorphic encryption computation. The homomorphic encryption calculating module 11 may transmit the first ciphertext [E1(m1, S1)] to the first key switching module 21. The first electronic apparatus 100-1 may convert the first ciphertext [E1(m1, S1)] to the second ciphertext [E2(m1, S2)] using the first key switching module 21. Operations thereafter may correspond to the description in FIG. 8.

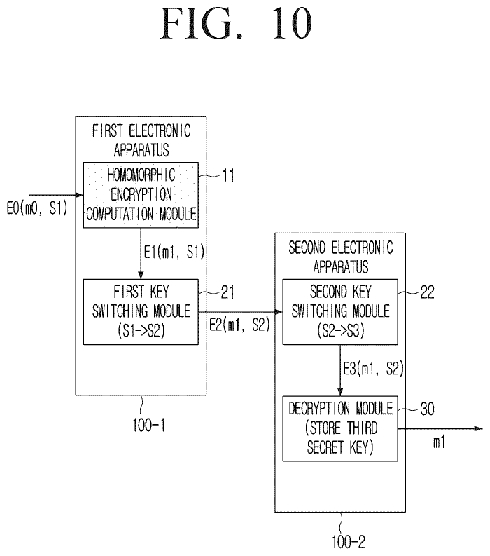

FIG. 10 is a diagram illustrating a key switching and a decrypting operation being performed in a same apparatus according to an embodiment.

The first electronic apparatus 100-1 and the second electronic apparatus 100-2 of FIG. 10 may correspond to the first electronic apparatus 100-1 and the second electronic apparatus 100-2 in FIG. 9.

Referring to an embodiment of FIG. 10, the second electronic apparatus 100-2 may include the decryption module 30. In an embodiment of FIG. 9, the key switching module and the decryption module 30 have been described as respectively being stored in individual apparatuses. In an embodiment of FIG. 10, the key switching module and the decryption module 30 may be included in one apparatus.

The first electronic apparatus 100-1 may include the homomorphic encryption calculating module 11 and the first key switching module 21. The second electronic apparatus 100-2 may include the second key switching module 22 and the decryption module 30.

The second electronic apparatus 100-2 may convert the second ciphertext [E2(m1, S2)] to the third ciphertext [E3(m1, S3)] using the second key switching module 22. The second key switching module 22 may transmit the third ciphertext [E3(m1, S3)] to the decryption module 30. The second electronic apparatus 100-2 may obtain the plaintext data m1 corresponding to the third ciphertext [E3(m1, S3)] using the decryption module 30. The second electronic apparatus 100-2 may transmit the plaintext data m1 to another apparatus.

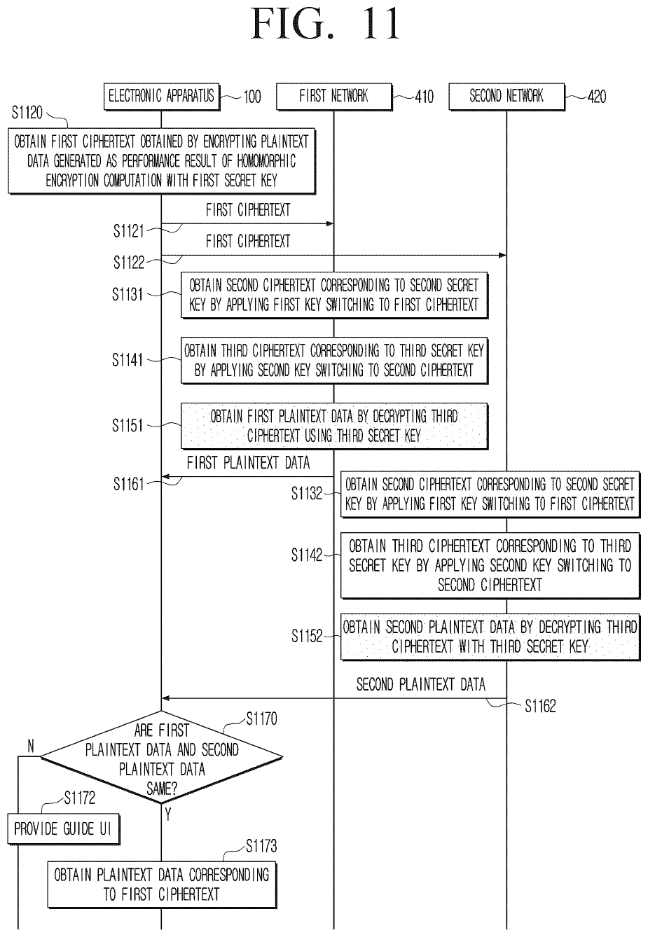

FIG. 11 is a diagram illustrating an operation for obtaining plaintext data from a plurality of networks according to an embodiment.

Step S1120 of FIG. 11 may correspond to step S520 in FIG. 5. Steps S1131 and S1132 of FIG. 11 may correspond to step S530 of FIG. 5. Steps S1141 and S1142 of FIG. 11 may correspond to step S540 of FIG. 5. Steps S1151 and S1152 of FIG. 11 may correspond to step S550 in FIG. 5.

Referring to FIG. 11, the electronic apparatus 100 may be communicatively connected with a first network 410 and a second network 420. The first network 410 and the second network 420 may be individual systems for key switching.

The first network 410 and the second network 420 may each include a plurality of key switching nodes (or modules) individually.

As an example, the first network 410 may be one apparatus. The one apparatus may include a plurality of key switching modules.

As an example, the first network 410 may be a system formed of a plurality of apparatuses. Each apparatus may include a key switching module, individually.

The electronic apparatus 100 may obtain the first ciphertext [E1(m1, S1)] generated as a result of homomorphic encryption computation (S1120). The first ciphertext [E1(m1, S1)] may be data that encrypted the plaintext data m1 with the first secret key S1.

The electronic apparatus 100 may transmit the first ciphertext [E1(m1, S1)] to the first network 410 (S1121). The electronic apparatus 100 may transmit the first ciphertext [E1(m1, S1)] to the second network 420 (S1122).

The first network 410 may receive the first ciphertext [E1(m1, S1)] from the electronic apparatus 100. The first network 410 may obtain the second ciphertext [E2(m1, S2)] corresponding to the second secret key S2 by applying first key switching to the first ciphertext [E1(m1, S1)](S1131). The first network 410 may obtain the third ciphertext [E3(m1, S3)] corresponding to the third secret key S3 by applying second key switching to the second ciphertext [E2(m1, S2)](S1141). The first network 410 may obtain a first plaintext data m1 by decrypting the third ciphertext with the third secret key S3 (S1151). The first network 410 may transmit the first plaintext data m1 to the electronic apparatus 100 (S1161).

The second network 420 may receive the first ciphertext [E1(m1, S1)] from the electronic apparatus 100. The second network 420 may obtain the second ciphertext [E2(m1, S2)] corresponding to the second secret key S2 by applying first key switching to the first ciphertext [E1(m1, S1)](S1132). The second network 420 may obtain the third ciphertext [E3(m1, S3)] corresponding to the third secret key S3 by applying second key switching to the second ciphertext [E2(m1, S2)](S1142). The second network 420 may obtain a second plaintext data m1 by decrypting the third ciphertext with the third secret key S3 (S1152). The second network 420 may transmit the second plaintext data m1 to the electronic apparatus 100 (S1162).

The electronic apparatus 100 may receive the first plaintext data m1 from the first network 410. The electronic apparatus 100 may receive the second plaintext data m1 from the second network 420.

The electronic apparatus 100 may identify whether the first plaintext data m1 and the second plaintext data m1 are the same (S1170). The electronic apparatus 100 may identify whether plaintext data obtained from each of the networks are the same. If the first network 410 and the second network 420 are both in normal environments, the plaintext data obtained from each network may be the same.

If the first plaintext data m1 and the second plaintext data m1 are not the same (S1170-N), the electronic apparatus 100 may provide a guide UI (S1172). The guide UI may include information for notifying that the first plaintext data m1 and the second plaintext data m1 are not the same. The guide UI may include information indicating that at least one network of the first network 410 and the second network 420 has an error in the key switching operation and the decryption operation.

If the first plaintext data m1 and the second plaintext data m1 are the same (S1170-Y), the electronic apparatus 100 may obtain the plaintext data m1 corresponding to the first ciphertext [E1(m1, S1)](S1173). The electronic apparatus 100 may ultimately determine the first plaintext data m1 and the second plaintext data m1 as the plaintext data m1 corresponding to the first ciphertext [E1(m1, S1)].

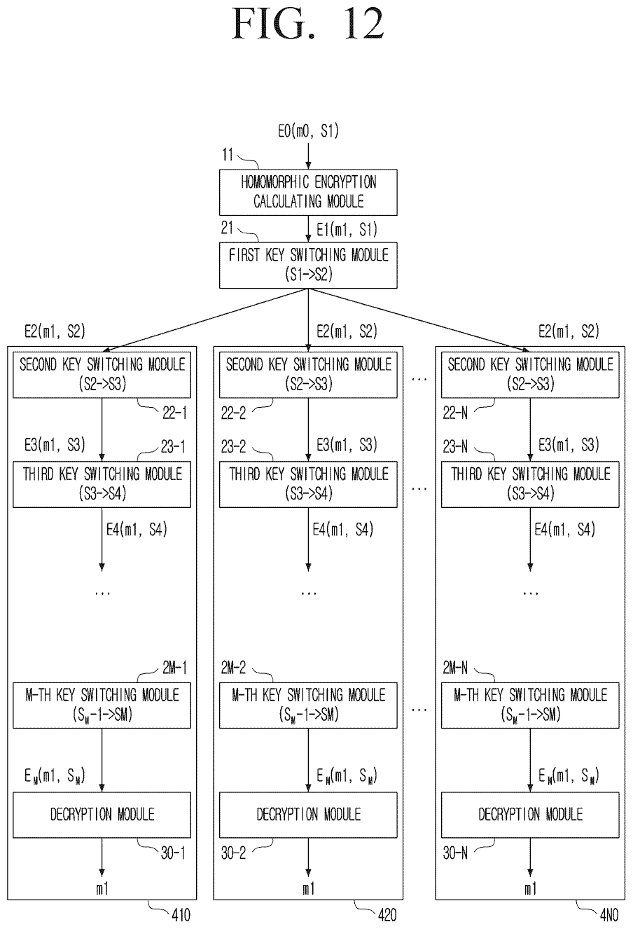

FIG. 12 is a diagram illustrating an operation for obtaining plaintext data individually from each of a plurality of networks according to an embodiment.

The modules described in FIG. 12 may correspond to the description of FIG. 4.

The homomorphic encryption calculating module 11 may receive the input data [E0(m0, S1)]. The homomorphic encryption calculating module 11 may obtain the first ciphertext [E1(m1, S1)] by performing homomorphic encryption computation with respect to the input data [E0(m0, S1)]. The homomorphic encryption calculating module 11 may transmit the first ciphertext [E1(m1, S1)] to the first key switching module 21.

The first key switching module 21 may convert the first ciphertext [E1(m1, S1)] to the second ciphertext [E2(m1, S2)].

The first key switching module 21 may transmit the second ciphertext [E2(m1, S2)] to the first network 410, the second network 420, and an N-th network 4N0.

The first network 410 may receive the second ciphertext [E2(m1, S2)] from the first key switching module 21. The first network 410 may convert the second ciphertext [E2(m1, S2)] to the third ciphertext [E3(m1, S3)] using a second key switching module 22-1. The first network 410 may convert the third ciphertext [E3(m1, S3)] to the fourth ciphertext [E4(m1, S4)] using a third key switching module 23-1. An M-th key switching module 2M-1 may obtain the ciphertext [EM(m1, SM)] encrypted the secret key SM. A decryption module 30-1 may obtain the first plaintext data m1. The first network 410 may obtain the first plaintext data m1.

The second network 420 may also obtain the second plaintext data m1 with the same method as the first network 410.

The N-th network 4N0 may also obtain a third plaintext data m1 with the same method as the first network 410.

If an error is not generated in all networks, the first plaintext data m1, the second plaintext data m1, and the third plaintext data m1 may all be the same.

If an error is generated in any one network, the first plaintext data m1, the second plaintext data m1, and the third plaintext data m1 may not all be the same.

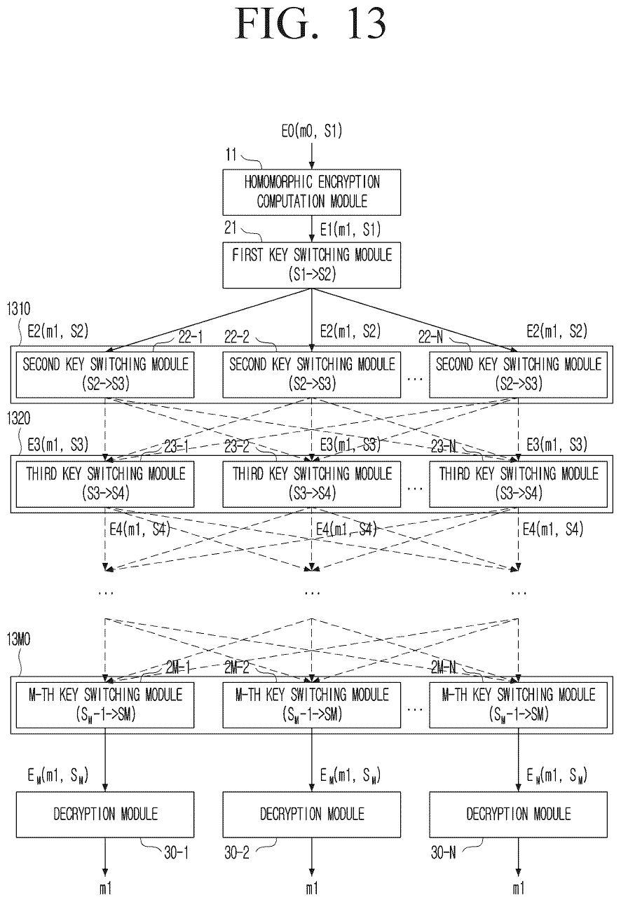

FIG. 13 is a diagram illustrating an operation for dividing key switching into a plurality of levels according to an embodiment.

The modules described in FIG. 13 may correspond to the description in FIG. 12. However, unlike FIG. 12, a plurality of key switching modules may be interconnected in FIG. 13.

The first key switching module 21 may transmit the second ciphertext [E2(m1, S2)] to a first switching group 1310. The first switching group 1310 may include a plurality of second key switching modules 22-1, 22-2, and 22-N.

The first key switching module 21 may transmit the second ciphertext [E2(m1, S2)] to the plurality of second key switching modules 22-1, 22-2, and 22-N included in the first switching group 1310.

Each of the second switching modules may convert the second ciphertext [E2(m1, S2)] to the third ciphertext [E3(m1, S3)]. The plurality of second key switching modules 22-1, 22-2, and 22-N may transmit the third ciphertext [E3(m1, S3)] to a second switching group 1320. The second switching group 1320 may include a plurality of second switching modules 23-1, 23-2, and 23-N.

The plurality of second switching modules 23-1, 23-2, and 23-N may transmit the third ciphertext [E3(m1, S3)] to a plurality of third key switching modules 23-1, 23-2, and 23-N included in the second switching group 1320.

The plurality of second switching modules 23-1, 23-2, and 23-N may convert the third ciphertext [E3(m1, S3)] to the fourth ciphertext [E4(m1, S4)]. The plurality of third key switching modules 23-1, 23-2, and 23-N may transmit the fourth ciphertext [E4(m1, S4)] to a switching group of a next level.

An M-th switching group 13M0 of a final level may include a plurality of switching modules 2M-1, 2M-2, and 2M-N. The plurality of switching modules 2M-1, 2M-2, and 2M-N may transmit the respectively obtained plaintext data to the decryption module.

As an example, a switching module 2M-1 of the final level may transmit the ciphertext [EM(m1, SM)] to a first decryption module 30-1. The first decryption module 30-1 may obtain the first plaintext data m1 based on the secret key SM.

As an example, a switching module 2M-2 of the final level may transmit the ciphertext [EM(m1, SM)] to a second decryption module 30-2. The second decryption module 30-2 may obtain the second plaintext data m1 based on the secret key SM.

As an example, a switching module 2M-N of the final level may transmit the ciphertext [EM(m1, SM)] to an N-th decryption module 30-N. The N-th decryption module 30-N may obtain an N-th plaintext data m1 based on the secret key SM.

If all groups and modules operate normally, a plurality of plaintext data that is obtained may be the same.

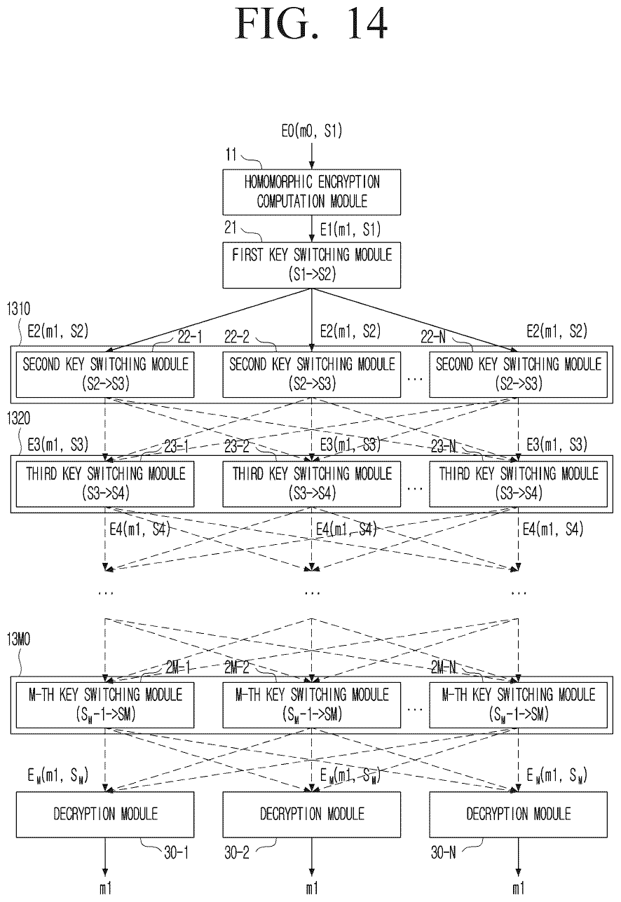

FIG. 14 is a diagram illustrating an operation for obtaining a plurality of decrypting calculation results by each of a plurality of decryption modules according to an embodiment.

The modules shown in FIG. 14 may correspond to the description in FIG. 13. However, unlike FIG. 13, the switching module 2M-N of the final level may transmit the ciphertext [EM(m1, SM)] to each of a plurality of decryption modules 30-1, 30-2, and 30-3 in FIG. 14.

As an example, the switching module 2M-1 of the final level may transmit the ciphertext [EM(m1, SM)] to the first decryption module 30-1, the second decryption module 30-2, and the N-th decryption module 30-N.

As an example, the switching module 2M-2 of the final level may transmit the ciphertext [EM(m1, SM)] to the first decryption module 30-1, the second decryption module 30-2, and the N-th decryption module 30-N.

As an example, the switching module 2M-N of the final level may transmit the ciphertext [EM(m1, SM)] to the first decryption module 30-1, the second decryption module 30-2, and the N-th decryption module 30-N.

The first decryption module 30-1 may obtain the plaintext data m1 based on the secret key SM. The first decryption module 30-1 may obtain an N-number of ciphertexts [EM(m1, SM)]. Every time the ciphertext [EM(m1, SM)] is received, the first decryption module 30-1 may obtain the plaintext data m1.

The second decryption module 30-2 may obtain the plaintext data m1 based on the secret key SM. The second decryption module 30-2 may obtain the N-number of ciphertexts [EM(m1, SM)]. Every time the ciphertext [EM(m1, SM)] is received, the second decryption module 30-2 may obtain the plaintext data m1.

A third decryption module 30-3 may obtain the plaintext data m1 based on the secret key SM. The third decryption module 30-3 may obtain the N-number of ciphertexts [EM(m1, SM)]. Every time the ciphertext [EM(m1, SM)] is received, the third decryption module 30-3 may obtain the plaintext data m1.

The electronic apparatus 100 may analyze the obtained plurality of plaintext data m1. The electronic apparatus 100 may determine whether a key switching system is operating normally based on an analysis result.

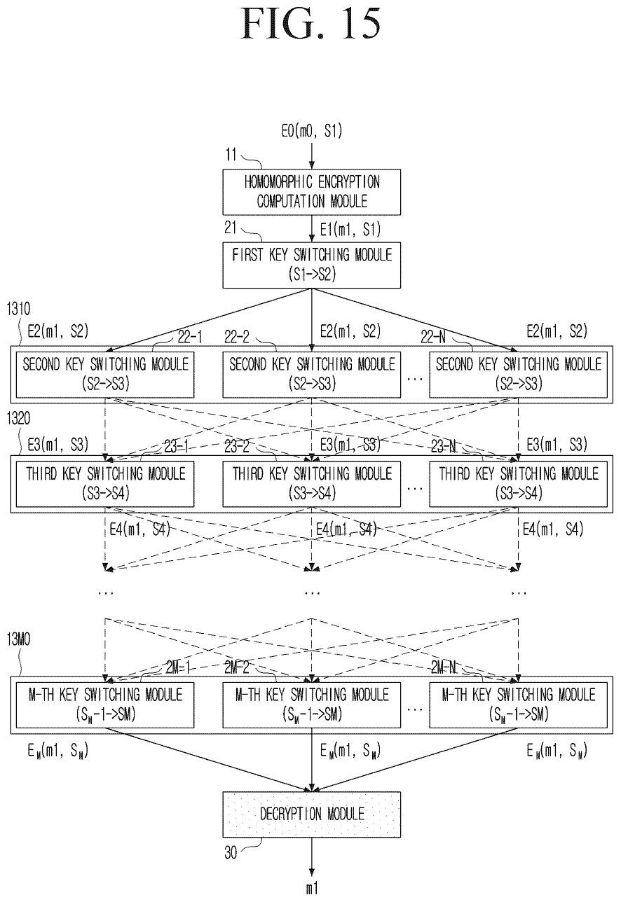

FIG. 15 is a diagram illustrating an operation for obtaining a plurality of decrypting calculation results by one decryption module, respectively, according to an embodiment.

The modules shown in FIG. 15 may correspond to the description in FIG. 13. However, unlike FIG. 13, the decryption module 30 may be one in FIG. 15.

The decryption module 30 may obtain the N-number of ciphertexts [EM(m1, SM)]. Every time the ciphertext [EM(m1, SM)] is received, the decryption module 30 may obtain the plaintext data m1.

The electronic apparatus 100 may analyze the obtained plurality of plaintext data m1. The electronic apparatus 100 may determine whether the key switching system is operating normally based on the analysis result.

In FIG. 12 to FIG. 15, an embodiment of another switching module other than the first key switching module 21 being present in plurality has been described.

According to another embodiment, the first key switching module 21 may be present in plurality. The first key switching module 21 may be included in each network.

Methods according to the various embodiments of the disclosure described above may be implemented in an application form installable in an electronic apparatus of the related art.

The methods according to the various embodiments of the disclosure described above may be implemented with only a software upgrade, or a hardware upgrade for the electronic apparatus of the related art.

The various embodiments of the disclosure described above maybe performed through an embedded server provided in the electronic apparatus, or at least one external server of the electronic apparatus and the display apparatus.

According to an embodiment of the disclosure, the various embodiments described above may be implemented with software including instructions stored in a machine-readable storage media (e.g., computer). The machine may call the stored instructions from the storage media, and as an apparatus operable according to the called instructions, may include the electronic apparatus according to the above-mentioned embodiments. Based on a command being executed by the processor, the processor may directly or using other elements under the control of the processor perform a function relevant to the command. The command may include a code generated by a compiler or executed by an interpreter. The machine-readable storage media may be provided in a form of a non-transitory storage medium. Herein, ‘non-transitory’ merely means that the storage medium is tangible and does not include a signal, and the term does not differentiate data being semi-permanently stored or being temporarily stored in the storage medium.

According to an embodiment of the disclosure, a method according to the various embodiments described above may be provided included a computer program product. The computer program product may be exchanged between a seller and a purchaser as a commodity. The computer program product may be distributed in a form of a machine-readable storage medium (e.g., a compact disc read only memory (CD-ROM)), or distributed online through an application store. In the case of online distribution, at least a portion of the computer program product may be stored at least temporarily in the storage medium such as a server of a manufacturer, a server of an application store, or memory of a relay server, or temporarily generated.

Each of the elements (e.g., a module or a program) according to various embodiments described above may be formed as a single entity or a plurality of entities, and a portion of sub-elements of the above-mentioned sub-elements may be omitted, or other sub-elements may be further included in the various embodiments. Alternatively or additionally, a portion of the elements (e.g., modules or programs) may be integrated into one entity to perform the same or similar functions performed by the each of the relevant elements prior to integration. Operations performed by a module, a program, or another element, in accordance with various embodiments, may be executed sequentially, in a parallel, repetitively, or in a heuristic manner, or at least a portion of the operations may be executed in a different order, omitted or a different operation may be added.

While the disclosure has been illustrated and described with reference to example embodiments thereof, it will be understood that the embodiments are intended to be illustrative, not limiting. It will be understood by those skilled in the art that various changes in form and details may be made therein without departing from the true spirit and full scope of the disclosure, including the appended claims and their equivalents.

### DESCRIPTION OF THE REFERENCE NUMERALS

100: electronic apparatus
110: at least one processor
120: memory
130: communication interface

1. An electronic apparatus processing homomorphic encryption, comprising:
at least one processor comprising processing circuitry; and
memory,
wherein the at least one processor is configured to
obtain a first ciphertext by performing homomorphic encryption on plaintext data with a first secret key,
obtain, through a first key switching module, a second ciphertext corresponding to a second secret key based on the first ciphertext,
transmit the second ciphertext to the second key switching module,
obtain, through a second key switching module, a third ciphertext corresponding to a third secret key based on the second ciphertext,
transmit the third ciphertext to a decryption module, and
obtain, through the decryption module, the plaintext data by decrypting the third ciphertext based on the third secret key.

2. The electronic apparatus of claim 1,
wherein the at least one processor is configured to
receive input data encrypted with the first secret key, and
obtain, through a homomorphic encryption calculating module, the first ciphertext by performing a pre-set homomorphic encryption computation with respect to the input data.

3. The electronic apparatus of claim 1,
wherein the first key switching module comprises
a first function that converts a ciphertext corresponding to the first secret key to a ciphertext corresponding to the second secret key.

4. The electronic apparatus of claim 1,
wherein the second key switching module comprises
a second function that converts a ciphertext corresponding to the second secret key to a ciphertext corresponding to the third secret key.

5. The electronic apparatus of claim 1,
wherein the decryption module is a module that performs decryption of a ciphertext corresponding to the third secret key.

6. The electronic apparatus of claim 1, comprising:
a communication interface,
wherein the at least one processor is configured to
receive, through the communication interface, a user input for decrypting the first ciphertext from an external apparatus, and
transmit, based on the second ciphertext being obtained based on the user input, the second ciphertext to the second key switching module.

7. The electronic apparatus of claim 6,
wherein the at least one processor is configured to
generate, based on the second ciphertext being obtained based on the user input, a first control signal comprising a first command for transmitting a decryption result to the external apparatus and a second command for requesting key switching of the second ciphertext, and
transmit the first control signal and the second ciphertext to the second key switching module.

8. The electronic apparatus of claim 7,
wherein the at least one processor is configured to
convert, based on the first control signal being generated, the second ciphertext to the third ciphertext through the second key switching module, and
transmit, based on the third ciphertext being obtained, the third ciphertext to the decryption module.

9. The electronic apparatus of claim 8,
wherein the at least one processor is configured to
generate, based on the third ciphertext being obtained, a second control signal comprising the first command for transmitting the decryption result to the external apparatus and a third command for requesting decryption of the third ciphertext, and
transmit the second control signal and the third ciphertext to the decryption module.

10. The electronic apparatus of claim 9,
wherein the at least one processor is configured to
obtain, based on the second control signal being generated, the plaintext data by decrypting the third ciphertext with the third secret key through the decryption module, and
transmit, based on the plaintext data being obtained, the plaintext data to the external apparatus based on the first command through the communication interface.

11. A homomorphic encryption system comprising a first electronic apparatus, a second electronic apparatus, and a third electronic apparatus,
wherein the first electronic apparatus is configured to:
obtain a first ciphertext by performing homomorphic encryption on plaintext data with a first secret key,
obtain, through a first key switching module, a second ciphertext corresponding to a second secret key based on the first ciphertext, and
transmit the second ciphertext to the second electronic apparatus,
wherein the second electronic apparatus is configured to
receive the second ciphertext,
obtain, through a second key switching module, a third ciphertext corresponding to a third secret key based on the second ciphertext, and
transmit the third ciphertext to the third electronic apparatus, and
wherein the third electronic apparatus is configured to
receive the third ciphertext, and
obtain, through a decryption module, the plaintext data by decrypting the third ciphertext based on the third secret key.

12. The system of claim 11,
wherein the first electronic apparatus is configured to
receive input data encrypted with the first secret key, and
obtain, through a homomorphic encryption calculating module, the first ciphertext by performing a pre-set homomorphic encryption computation with respect to the input data.

13. The system of claim 11,
wherein the first key switching module comprises
a first function that converts a ciphertext corresponding to the first secret key to a ciphertext corresponding to the second secret key.

14. The system of claim 11,
wherein the second key switching module comprises
a second function that converts a ciphertext corresponding to the second secret key to a ciphertext corresponding to the third secret key.

15. The system of claim 11,
wherein the decryption module is a module that performs decryption of a ciphertext corresponding to the third secret key.

16. The system of claim 11,
wherein the first electronic apparatus is configured to
receive a user input for decrypting the first ciphertext from an external apparatus, and
transmit, based on the second ciphertext being obtained based on the user input, the second ciphertext to the second electronic apparatus.

17. The system of claim 16,
wherein the first electronic apparatus is configured to
generate, based on the second ciphertext being obtained based on the user input, a first control signal comprising a first command for transmitting a decryption result to the external apparatus and a second command for requesting key switching of the second ciphertext, and
transmit the first control signal and the second ciphertext to the second electronic apparatus.

18. The system of claim 17,
wherein the second electronic apparatus is configured to
convert, based on the first control signal and the second ciphertext being received, the second ciphertext to the third ciphertext through the second key switching module, and
transmit, based on the third ciphertext being obtained, the third ciphertext to the third electronic apparatus.

19. The system of claim 18,
wherein the second electronic apparatus is configured to
generate, based on the third ciphertext being obtained, a second control signal comprising the first command for transmitting the decryption result to the external apparatus and a third command for requesting decryption of the third ciphertext, and
transmit the second control signal and the third ciphertext to the third electronic apparatus.

20. The system of claim 19,
wherein the third electronic apparatus is configured to
obtain, based on the second control signal and the third ciphertext being received, the plaintext data by decrypting the third ciphertext with the third secret key through the decryption module, and
transmit, based on the plaintext data being obtained, the plaintext data to the external apparatus based on the first command.
